(19) United States
(12) Patent Application Publication
(10) Pub. No.: US 2017/0342697 A1
(43) Pub. Date: Nov. 30, 2017

(54) Turbulating Apparatus For A Drywell

(71) Applicant: Torrent Resources, Inc., Phoenix, AZ (US)

(72) Inventor: James Mayer, Scottsdale, AZ (US)

(21) Appl. No.: 15/165,553

(22) Filed: May 26, 2016

(51) Int. Cl. E03F 1/00; B01D 21/24; C02F 1/00; C02F 103/00

(52) U.S. Cl. CPC E03F 1/002; C02F 1/006; B01D 21/2405; C02F 2201/002; C02F 2301/024; C02F 2103/001

(57) ABSTRACT

A turbulating apparatus for a drywell includes a frusto-conical sidewall having an upstream inlet and an opposed downstream outlet. The sidewall has an inner surface on which a plurality of vanes are fixed and extend helically between the inlet and outlet. The apparatus hangs from a top of the drywell and turbulates water to prevent the aggregation of debris inside the drywell.

### FIELD OF THE INVENTION

The present invention relates generally to storm water drywells, and more particularly to systems for turbulating water in drywells.

### BACKGROUND OF THE INVENTION

Standing water is a major civil engineering issue for most towns and cities. Standing water is often caused by stormwater that collects in parks, basins, hardscape depressions, and other similar community and municipal planning oversights. Generally, cities and towns do plan to handle stormwater. Most streets are constructed with drainage structures such as gutters which channel stormwater from the road into the storm sewer system. Systems such as these are often sufficient for handling most rainfall events. Occasionally, because of environmental conditions and city planning decisions in many places, there are times when the gutter system is not sufficient. For instance, in the desert, rains are intermittent until the monsoon season, during which heavy downpours occur frequently. Because the top layer of earth in the desert is often poor-quality clay or caliche, it cannot absorb large amounts of rain, and so monsoon rains often flow across the surface of desert ground rather than quickly percolating into and through that ground. City planners account for this by designing roads as guides so that stormwater is often channeled into parks, fields, and other similar areas where it can collect and be directed to the groundwater. These areas include drywells, which draw and drain the stormwater for dissipation into the ground and the local groundwater. Typically, city planners will install drywells purposefully to handle these large collections of stormwater, and similarly purposefully direct the neighborhood stormwater into the collection area and toward the drywell.

These drywells range from simple holes in the ground filled with rock backfill into which the stormwater is directed to much more complicated wells with manhole covers, settling chambers, and filter assemblies for cleansing stormwater before releasing it back into the groundwater. In residential areas, cleansing the stormwater before returning it to the local groundwater is vitally important, as the stormwater has often moved across streets, parking lots, and other areas laden with oils, fuels, and other contaminants. Cities will install complicated and expensive drywells to combat all of these issues.

Regardless of the size and complexity of the drywells, however, they generally need to be maintained on a regular basis. Failure to maintain a drywell will result in a degradation of its ability to efficiently recharge and return stormwater back to the groundwater. In some cases, failure to maintain a drywell will result in the complete failure of the drywell to operate.

Many drywells are two-stage drywells having two separate compartments or settling chambers with a pipe extending between. Generally, the intake of the pipe, located in the first of the settling chambers, will have a filter. As dirty stormwater pours into the first settling chamber, debris in the stormwater can collect against and clog the filter. Additionally, accumulated debris on the bottom of the settling chamber will eventually pile high enough to block the filter. This requires a maintenance crew to roll to the drywell and clean it. A jet rod and vactor hose are used to break up and vacuum off accumulated debris from the settling chamber and the filter itself. In dirtier locations, maintenance crews have to visit the drywells more frequently. There is an incurred cost when a crew cleans and maintains the drywell, and so there is a need for reducing the number of cleaning trips that a crew must make. Additionally, there is a need for drywells to continue to operate as efficiently as possible for as long as possible.

### SUMMARY OF THE INVENTION

A turbulating apparatus for a drywell includes a frusto-conical sidewall having an upstream inlet and an opposed downstream outlet. The sidewall has an inner surface on which a plurality of vanes are fixed and extend helically between the inlet and outlet. The apparatus hangs from a top of the drywell and turbulates water to prevent the aggregation of debris inside the drywell and keeps the filter clean.

### BRIEF DESCRIPTION OF THE DRAWINGS

Referring to the drawings:

FIG. 1 is a section view of a drywell installed in the ground and including a turbulating device;

FIG. 2 is a top perspective view of the turbulating device in isolation;

FIG. 3 is a side elevation view of the turbulating device in isolation;

FIG. 4 is a top plane view of the turbulating device in isolation; and

FIG. 5 is an enlarged section view of a drywell installed in the ground and including a turbulating device.

### DETAILED DESCRIPTION

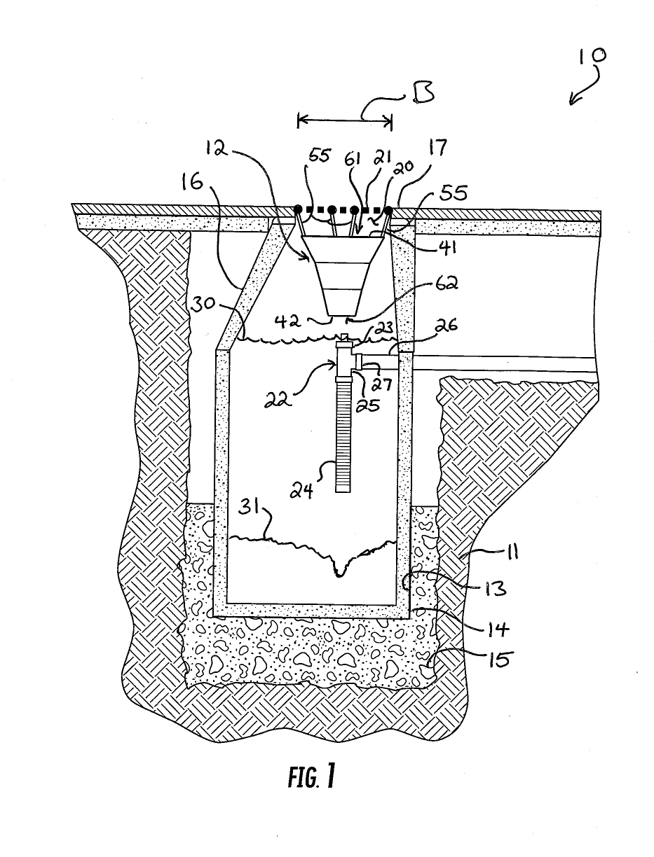

Reference now is made to the drawings, in which the same reference characters are used throughout the different figures to designate the same elements. FIG. 1 is a section view of a water drainage system 10, known as a stormwater drywell 10, for recharging and returning stormwater to the ground 11. The drywell 10 includes a turbulating device 12 for directing and agitating water in the drywell 10, to prevent degradation of the drywell 10, maintain the operating efficiency of the drywell 10, and clean internal components of the drywell 10.

The drywell 10 includes an excavated shaft 13 formed into the ground 11 to receive a settling chamber 14 and rock infill 15 surrounding the settling chamber 14. The settling chamber 14 is known as the primary settling chamber in a two-chamber drywell system. A manhole entry device, such as a modified manhole cone 16, is positioned at a top 17 of the settling chamber 14 to provide a manhole 20 through which stormwater can flow. The manhole 20 is covered by a grate 21 disposed at grade level and bolted to the manhole cone 16 to prevent unauthorized access to the settling chamber 14.

An intake pipe 22 is disposed vertically within the settling chamber 14. The intake pipe 22 includes an anti-siphon valve 23, a long vertical filter 24, and a tee 25 disposed therebetween. The filter 24 depends from the tee 25, the anti-siphon valve 23 is directed upward from the tee 25, and an overflow pipe 26 is connected to an outlet 27 of the tee 25 and extends out of the settling chamber 14. The filter 24 screens the stormwater before communicating it to a secondary settling chamber in the drywell system. The secondary settling chamber additionally filters the water before returning and recharging the water to the ground 11. The primary settling chamber 14 is fluid impervious, such that water is retained within the settling chamber 14 so that the water can be filtered and passed to the secondary settling chamber.

As stormwater 30 collects in the settling chamber 14, the water level rises. When the water level is below the filter 24, the collected water 30 is retained in the settling chamber 14. When the water level reaches the filter 24, the collected stormwater 30 is still retained in the settling chamber 14. However, once the water level rises further, to the height of the outlet 26 in the tee 25, collected stormwater 30 exits the settling chamber 14. To exit the settling chamber 14 and communicate to the secondary settling chamber, collected water 30 must first enter the intake pipe 22. Collected stormwater 30 enters the intake pipe 22 through the filter 24. Collected stormwater 30 on the outside of the filter 24 is thus pre-filtered, and collected stormwater 30 on the inside of the filter 24 is filtered water 30.

The collected stormwater 30 is filtered of larger debris and contaminants at the filter 24. The filter 24 is quite tall, extending from approximately one-third of the depth of the settling chamber 14 to approximately two-thirds of the depth of the settling chamber 14. In some embodiments, the filter 24 is approximately four feet tall. Further, the filter 24 completely encircles the intake pipe 22 below the tee 25. The filter 24 is a slotted pipe having approximately 32 slots per foot. The slots are formed into and through the sidewall of the pipe.

As collected stormwater 30 passes through the filter 24, the debris and contaminants filtered out are left behind in the settling chamber 14. They accumulate at the bottom of the settling chamber 14. As more and more stormwater 30 passes through the filter 24, more and more debris is left at the bottom of the settling chamber 14, as indicated with the reference character 31 in FIG. 1. The accumulation of debris 31 grows and rises from the bottom. Eventually, the debris gains a substantial mass. The debris 31 is dense; it includes fine debris 31 that settles closely against other fine debris 31, and as more debris 31 settles, it compacts the debris 31 at the bottom. The debris 31 can thus become quite static and even hard, similar to concrete. As the debris 31 level rises, it reaches the bottom of the filter 24. However, the turbulating device 12 prevents debris 31 from covering the filter 24, thereby ensuring that water 30 can continue to flow through the filter 24.

Were it not for the turbulating device 12, the filter would be impaired in two ways. First, the slots would become dirty and clogged and thus requiring maintenance and cleaning. Second, debris 31 would rise around the filter 24 and continue to accumulate until the filter 24 was buried and unusable. At this point, a team would have to work on the drywell 10 to clean out the debris 31 with a jet rod and a vactor hose. However, the turbulating device 12 prolongs the time between cleanings by preventing debris 31 from accumulating around the filter 24.

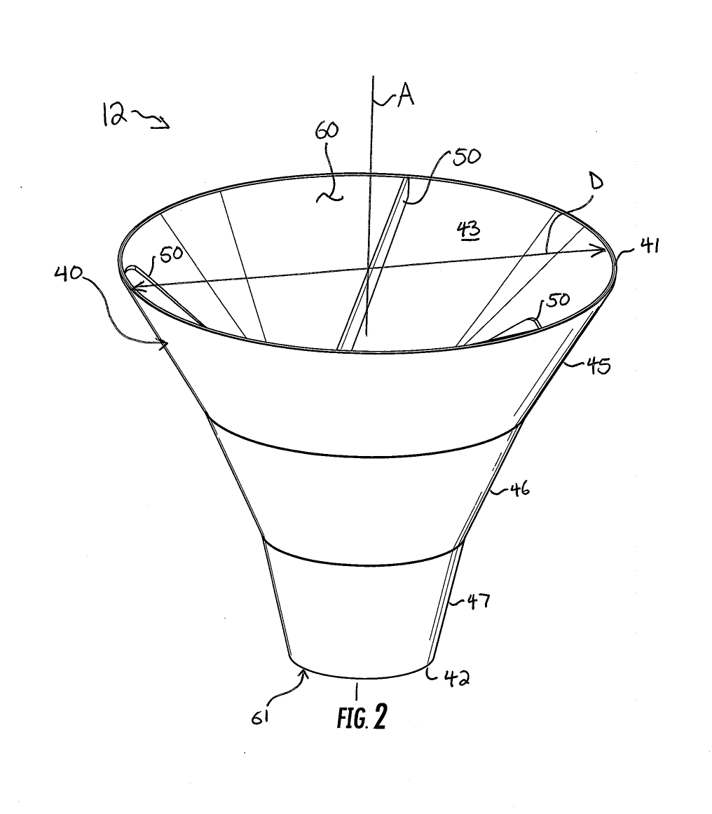

Turning now to FIG. 2, the turbulating device 12 is shown in detail. It includes a sidewall 40 having an annular top edge 41 and an opposed annular bottom edge 42. The sidewall 40 has an inner surface 43, an opposed outer surface 44, and is preferably constructed with three major sections: an upper sidewall section 45, a middle sidewall section 46, and a lower sidewall section 47. The upper sidewall section 45 is formed integrally to the middle sidewall section 46, and the middle sidewall section 46 is formed integrally to the lower sidewall section 47. Each of the sidewall sections has a different slope, as will be explained.

The sidewall 40 is frusto-conical; it has a conical shape truncated between two parallel planes. The top edge 41 has a diameter D and a corresponding circumference which are both larger than those of the bottom edge 42. The sidewall 40 tapers from the top edge 41 to the bottom edge 42. The sidewall 40 thus converges from the top edge 41 to the bottom edge 42. The sidewall 40 has a central axis A of rotational symmetry, and each of the sidewall sections has a convergent angle with respect to the axis A.

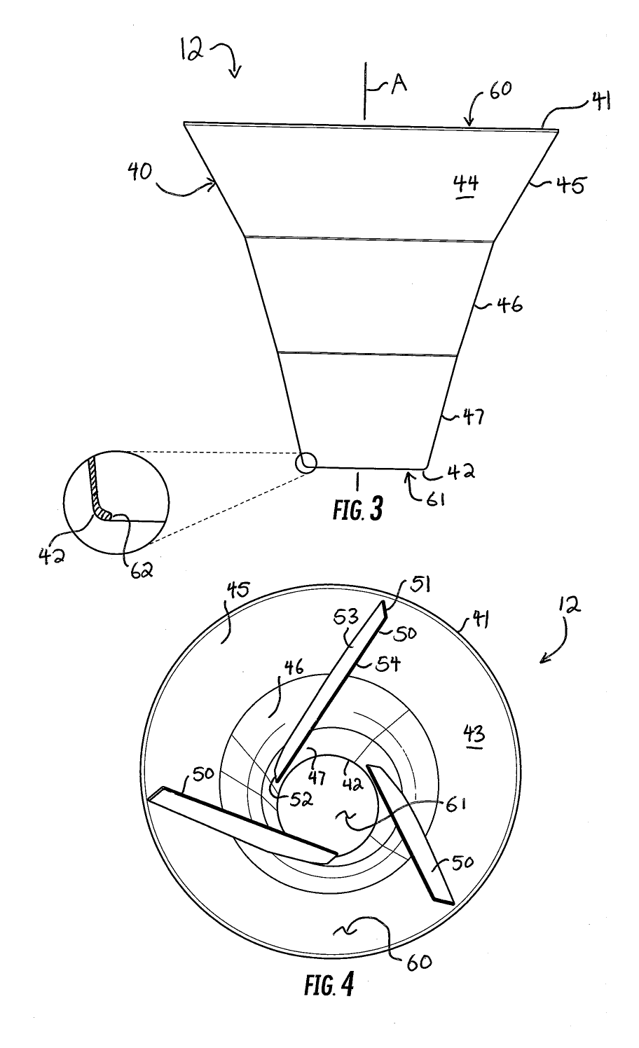

Referring to FIG. 3, which shows the turbulating device 12 in a side elevation view, the upper sidewall section 45 extends from the top edge 41 to the middle sidewall section 46. The upper sidewall section 45 continuously encircles the axis A and has an angle with respect to the axis A of approximately twenty-five degrees. It is the widest of all three of the sidewall sections, possessing the largest inlet and outlet diameters.

The middle sidewall section 46 extends from the bottom of the upper sidewall section 45 to the top of the lower sidewall section 47. The middle sidewall section 46 is integrally formed to both the upper and lower sidewall sections 45 and 47, and is preferably welded along continuous seams with each of those sections. In other embodiments, the sidewall 40 is formed entirely from a single sheet of strong material, such as metal, and is bent into the three sidewall sections. The middle sidewall section 46 has a steeper convergent pitch than does the upper sidewall section 45: the middle sidewall section 46 continuously encircles the axis A and has an angle with respect to the axis A of approximately twenty degrees.

The lower sidewall section 47 extends from the bottom of the middle sidewall section 46 to the bottom edge 42. The lower sidewall section 47 continuously encircles the axis A. It has a steeper convergent pitch than do either the upper or middle sidewall sections 45 and 46. The lower sidewall section 47 has an angle with respect to the axis A of approximately fifteen degrees. The lower sidewall section 47 is the narrowest of the three sidewall sections, possessing the smallest inlet and outlet diameters.

The inner surface 43 extends across each of the upper, middle, and lower sidewall sections 45, 46, and 47. The inner surface 43 is smooth and featureless but for three vanes 50 applied thereto. The vanes 50 are each identical, positioned apart from each other by one hundred twenty degrees, and wrap helically down toward the bottom edge 42 from the top edge 41. Only one vane 50 will be described given the structural identity of the vanes 50.

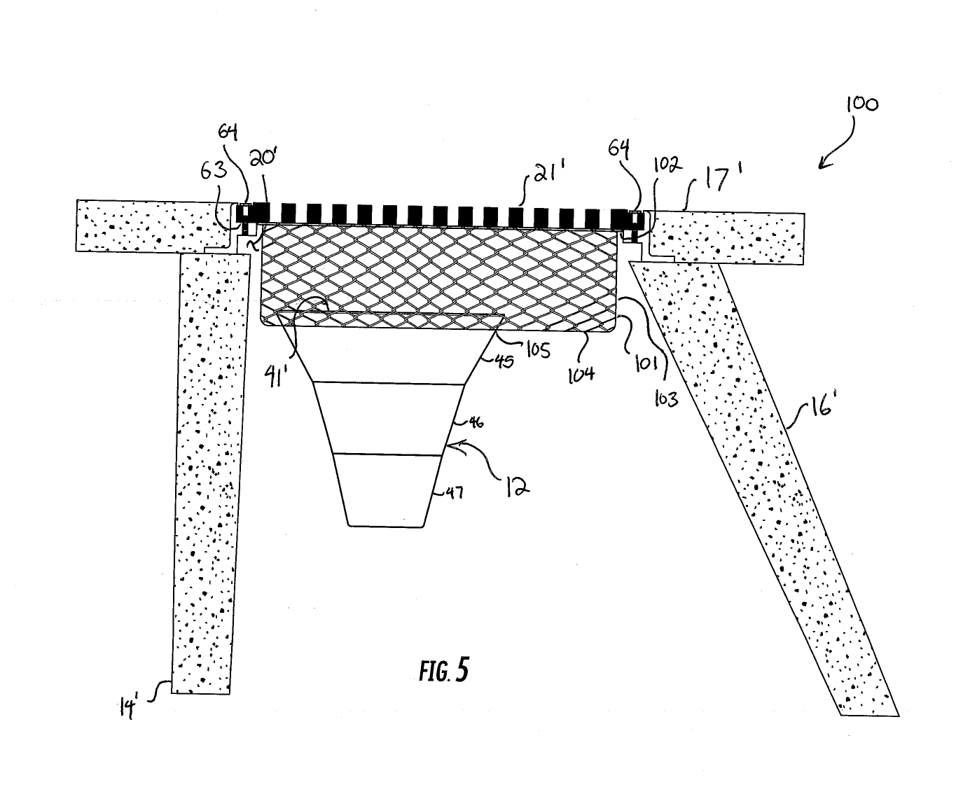

Referring to FIG. 4, which is a top plan view of the tabulating device 12, the vane 50 is shown as an upstanding, rigid, elongate element. The vane 50 has a top 51, an opposed bottom 52, a base 53, and a ridge 54. The base 53 is fixed, such as with welding or spot welding, to the inner surface 43 of the turbulating device 12 across each of the upper, middle, and lower sidewall sections 45, 46, and 47. The top 51 of the vane 50 is disposed on the inner surface 43 just below the top edge 41, and the vane 50 extends to the bottom 52 terminating just above the bottom edge 42. The vane 50 is helically positioned on the inner surface 43: rather than being oriented straight down the sidewall 40, the vane 50 angles counterclockwise (as shown in this view) as it depends down the inner surface 43.

The vanes 50 act to control and affect spinning of water entering the drywell 10. Returning to FIG. 1, four tie rods 55 are welded to the top edge 41 of the turbulating device 12 and extend upward to the grate 21, where each is welded securely thereto. The turbulating device 12 is thus disposed, or hangs, just below the grate 21, with the bottom edge 42 just above the intake pipe 22. Stormwater that has collected above the drywell 10 pours into the drywell 10 through the grate 21. The manhole 20 has a width B. The diameter D of the turbulating device 12 at the top edge 41 is just smaller than the width B, such that substantially all of the water which flows through the grate 21 passes directly into the turbulating device 12.

Referring briefly to FIG. 2, the top edge 41 bounds and defines a round inlet 60 into the turbulating device 12. The inlet 60 is upstream from an opposed outlet 61, which is bound and defined by the bottom edge 42. Stormwater flows into the inlet 60 and out the outlet 61. As stormwater pours into the turbulating device 12, it encounters the inner surface 43 thereof. The stormwater flows down the inner surface 43 with gravity, and the vanes 50 route the direction of the stormwater, so that it flows with a counterclockwise rotation as it moves downward. This creates a fast-moving turbulent flow of stormwater in the turbulating device 12 with a very high amount of centrifugal force. At the outlet 61, the bottom edge 42 of the sidewall 40 is turned radially inward to form an inner lip 62, as seen in the inset of FIG. 3, which is an enlarged section view at the outlet 61. This radially-directed inner lip 62 is turned inward toward the axis A, and causes stormwater exiting the turbulating device 12 to suddenly and violently deflect radially inward. However, the stormwater has collected helical speed and momentum, and therefore centrifugal force, and so the sudden inward deflection redirects the nozzle directly downward rather than radially outward, and causes the stormwater to become even more turbulent as it flows out. This act of making a flow of water turbulent is identified within this description as “turbulating.”

The outlet 62 of the turbulating device 12 is directed toward the intake pipe 22, such that stormwater exiting the outlet 61 violently and turbulently flows down onto and around the intake pipe 22. The stormwater prevents debris 31 from accumulating around the intake pipe 22 and in and around the filter 24. Because turbulent stormwater is directed over the filter 24, debris collected in the slots of the filter is worn and broken loose. Debris 31 near the filter 24 is similarly agitated: debris 31 is pushed away from the intake pipe 22, such that there is a hole, pit, or depression directly below the intake pipe 22, into which collected stormwater 30 can rise up and flow before moving through the filter 24.

FIG. 5 illustrates an alternate method of mounting a turbulating device 12′ in a drywell 100. FIG. 5 is a section view similar to FIG. 1, but is enlarged to show detail around a top 17′ of a settling chamber 14′. The embodiment of the drywell 100 shown in FIG. 5 is identical to the embodiment of the drywell 10 shown in FIG. 1 except as described below. As such, the same reference characters are used to identify the same parts of the drywells 10 and 100, but those used with respect to the drywell 100 are marked with a prime (“′”) symbol to differentiate the corresponding structural elements and features from those of the drywell 10. For instance, the drywell 100 includes the turbulating device 12′, settling chamber 14′, a manhole cone 16′, a top 17′, a manhole 20′, a grate 21′, etc. Whereas in the embodiment of the drywell 10 shown in FIG. 1, the turbulating device 12, four tie rods 55 are welded between the top edge 41 of the turbulating device 12 and the grate 21, the turbulating device 12′ depends from a basket 101 at the top 17′ of the drywell 100. The basket 101 includes a flat, rigid annular lip 102 at its top, an annular sidewall 103 depending vertically downward from the lip 102 formed of open wire mesh, and a wire mesh bottom 104. The mesh bottom 104 is formed with a circular opening 105 which is offset, or away from the geometric center of the bottom 104 of the basket 101. The circular opening 105 has a diameter which is slightly smaller than the diameter D of the turbulating device 12′ (as equivalently shown in FIG. 2 for the identical turbulating device 12). As such, when applied to the basket 101, the turbulating device 12′ is supported therein, with the top edge 41′ of the turbulating device 12′ above the circular opening 105, and with the upper sidewall section 45 in lateral contact with the circular opening 105. The basket 101 is constructed from a material or combination of materials having strong, rigid, and durable material characteristics, such as metal, and is sufficient to support the turbulating device 12 and water flowing therethrough. The basket 101 itself is seated into the manhole 20′. The manhole 20′ has an annular inner lip 63 on which the grate 21′ rests. The lip 102 of the basket 101 is placed against the inner lip 63 and rests thereupon, interposed between the inner lip 63 below and the grate 21′ above. The grate 21′ is heavy, and is also secured with fasteners 64 such that the grate 21′ cannot be removed. Thus the basket 101 is seated and securely fastened to the grate 21′ in the inner lip 63.

A preferred embodiment is fully and clearly described above so as to enable one having skill in the art to understand, make, and use the same. Those skilled in the art will recognize that modifications may be made to the described embodiment without departing from the spirit of the invention. To the extent that such modifications do not depart from the spirit of the invention, they are intended to be included within the scope thereof.

The invention claimed is:

1. Apparatus comprising:
a frusto-conical sidewall having an upstream inlet and an opposed downstream outlet;
an inner surface of the sidewall; and
a plurality of vanes fixed to the inner surface.

2. The apparatus of claim 1, wherein the vanes are arranged helically on the inner surface between the inlet and the outlet.

3. The apparatus of claim 1, wherein the outlet has an inner lip at the outlet.

4. The apparatus of claim 1, wherein each vane is an elongate member extending radially inward from the inner surface.

5. The apparatus of claim 1, wherein the vanes extend from the inlet to the outlet.

6. The apparatus of claim 1, wherein the sidewall comprises three major sections, including:
a first major section, proximate to the inlet, defining a first convergent annulus;
a second major section, below the first major section, defining a second convergent annulus; and
a third major section, proximate to the outlet, defining a third convergent annulus;
wherein the first convergent annulus, second convergent annulus, and third convergent annulus have different diameters.

7. The apparatus of claim 1, further comprising a plurality of tie rods extending upwardly from the inlet.

8. A drywell comprising:
a settling chamber having an open top;
turbulating means for turbulating a water flow into the settling chamber; and
the means disposed proximate to the open top of the settling chamber.

9. The drywell of claim 8, further comprising:
an intake pipe; and
the turbulating means is directed toward the intake pipe.

10. The drywell of claim 8, wherein the turbulating means comprises a frusto-conical sidewall having an inner surface.

11. The drywell of claim 10, further comprising a plurality of vanes fixed to the inner surface of the sidewall.

12. The drywell of claim 11, further comprising:
an upstream inlet and an opposed downstream outlet of the turbulating means; and
the vanes are arranged helically on the inner surface between the inlet and the outlet.

13. The apparatus of claim 12, further comprising a plurality of tie rods extending upwardly from the inlet to the top of the settling chamber.

14. The drywell of claim 10, wherein the sidewall comprises three major sections, including:
a first major section, proximate to the inlet, defining a first convergent annulus;
a second major section, below the first major section, defining a second convergent annulus; and
a third major section, proximate to the outlet, defining a third convergent annulus;
wherein the first convergent annulus, second convergent annulus, and third convergent annulus have different diameters.

15. A drywell comprising:
a settling chamber having an open top;
a turbulating body carried within the settling chamber proximate to the open top, the turbulating body including a sidewall having an upstream inlet and an opposed downstream outlet; and
a plurality of vanes fixed to an inner surface of the sidewall.

16. The drywell of claim 15, wherein the vanes are arranged helically on the inner surface between the inlet and the outlet.

17. The drywell of claim 15, wherein the outlet has an inner lip at the outlet.

18. The drywell of claim 15, wherein each vane is an elongate member extending radially inward from the inner surface.

19. The drywell of claim 15, wherein each of the vanes extend from the inlet to the outlet.

20. The drywell of claim 15, wherein the sidewall comprises three major sections, including:
a first major section, proximate to the inlet, defining a first convergent annulus;
a second major section, below the first major section, defining a second convergent annulus; and
a third major section, proximate to the outlet, defining a third convergent annulus;
wherein the first convergent annulus, second convergent annulus, and third convergent annulus have different diameters.
